(19) United States
(12) Patent Application Publication
(10) Pub. No.: US 2016/0036628 A1
(43) Pub. Date: Feb. 4, 2016

(54) METHOD AND SYSTEM FOR PERFORMING OUT-OF-BAND MANAGEMENT OF COMPUTING DEVICES OVER A WIRELESS WIDE-AREA NETWORK

(71) Applicant: Vineet Gupta, San Jose, CA (US)

(72) Inventor: Vineet Gupta, San Jose, CA (US)

(21) Appl. No.: 14/815,308

(22) Filed: Jul. 31, 2015

Related U.S. Application Data
(60) Provisional application No. 62/032,020, filed on Aug. 1, 2014.

(51) Int. Cl. H04L 12/24; H04W 4/00

(52) U.S. Cl. CPC H04L 41/08; H04W 4/005; H04W 84/04

(57) ABSTRACT

Provided herein are systems and methods for performing out-of-band management (e.g. IPMI, DCMI, remote KVM, Intel AMT or similar technology) of one or more computing devices, using its out-of-band (OOB) service processor and an on-board or attached communication module, which is capable of communicating over a wireless wide area network (WWAN) and optionally over IP-based network.

The present application claims priority to U.S. Provisional Patent Application Ser. No. 62/032,020, filed Aug. 1, 2014, the disclosure of which is herein incorporated by reference in its entirety.

### FIELD

Provided herein are systems and methods for performing out-of-band management (e.g. IPMI, DCMI, remote KVM, Intel AMT or similar technology) of one or more computing devices, using its out-of-band (OOB) service processor and an on-board or attached communication module, which is capable of communicating over a wireless wide area network (WWAN) and optionally over IP-based network. The OOB service processor is capable of communicating over WWAN regardless of the state of in-band processor and operating system of the computing device. Via WWAN, the computing device communicates with the M2M management platform, which in-turn, allows an out-of-band management application (running on a remote computing device) send/receive information to/from the computing device.

### BACKGROUND

Wireless Wide Area Network: A Wide-area network (WAN) is a communications network, which covers a relatively large geographic area, as compared to a local-area network (LAN). A Wireless Wide area network (WWAN) typically employs a cellular radio network to provide Wireless communications, possibly on citywide or even nationwide basis. One illustrative embodiment of a WWAN is a telecommunications network configured according to the GSM (Groupe Special Mobile) standard. The GSM standard uses digital channels for both speech and data and, thus, has been referred to as a second-generation (2G) mobile telephony system. Third-generation (3G) and fourth-generation (4G) versions of GSM networks allow simultaneous use of speech and data services and higher data rates than those provided by 2G networks. One feature of the GSM standard is the Subscriber Identity Module (SIM), commonly known as a SIM card. A SIM is a detachable smart card that stores an International Mobile Equipment Identity (IMEI) that uniquely identifies the phone or computing device on the GSM network.

Machine to Machine (M2M): Machine to Machine (M2M) refers to technologies that allow both wireless and wired systems to communicate with other devices. M2M is an integral part of the Internet of Things (IoT) and brings several benefits to industry and business in general as it has a wide range of applications such as industrial automation, logistics, Smart Grid, Smart Cities, health, defense etc. mostly for monitoring but also for control purposes.

M2M Service Platform: The M2M service platform typically is a cloud based software platform (could be hosted by a large enterprise for dedicated use) that offers a set of generic and specific functions and processes for the support of a variety of applications/use-cases enabled by the M2M technologies. These functions include, but are not limited to, management functions, such as service provisioning/activation/deactivation, usage monitoring/rating & billing, security functions as well as service monitoring & support and generic & specific application support functions. The M2M service platform communicates with the sends/receives data to/from the WWAN devices over the WWAN network(s) as well as the IP-based networks to enable communication with the customer specific applications and systems.

Out of Band Management: In the field of network computing, out-of-band (OOB) management involves the use of a dedicated management channel for device maintenance. OOB management allows a system administrator to monitor and manage computing devices and other network equipment by remote control regardless of the state of the in-band processor, or whether an operating system is installed or functional. By contrast, in-band management like VNC or SSH is based on software that must be installed on the remote system being managed and only works after the operating system has been booted and is functioning properly. This solution may be cheaper, but it does not allow access to low-level settings such as system BIOS, or the reinstallation of the operating system and cannot be used to fix problems that prevent the system from booting. Both in-band and out-of-band management are usually done through the network connection, but an out-of-band service processor typically uses a physically separated network connector. Also, an OOB service processor typically has at least partially independent power supply, and can power the main machine on and off through the network. One illustrative embodiment of a computing device capable of supporting OOB management is a computer server, but any computing/networking device could benefit from OOB management, including but not limited to: computer server, computer workstations, computer server racks, uninterruptible power supplies (UPS), network firewall equipment, network switch and router equipment.

OOB Service Processor: An OOB service processor is a separate, dedicated internal processor located on the motherboard of a server, a PCI card, or on the chassis of a blade server or telecommunications platform. It operates independently from the device's main (in-band) CPU and operating system (OS), even if the CPU or OS is locked up or otherwise inaccessible. The OOB Service processors monitor a device's on-board instrumentation (e.g. temperature sensors, CPU status, fan speed, voltages), provides remote reset or power-cycle capabilities, enables remote access to basic input/output system (BIOS) configuration or OS console information, and, in some cases, provides keyboard and mouse control. Depending on the manufacturer, OOB service processors may also provide console/video redirection capabilities to view server processes or to configure server parameters, system information on components installed, including ports used and devices connected, and event logs, notifications and alarms. There are several implementations of OOB service processor technology including but not limited to Intelligent Platform Management Interface, Intel's Active Management Technology (Intel AMT), HP Integrated Lights-Out, Dell DRAC.

Intelligent Platform Management Interface: The IPMI is one example of a standardized computer system interface used by system administrators for out-of-band management of computer systems and monitoring of their operation. It is a way to manage a computer that may be powered off or otherwise unresponsive by using a network connection to the hardware rather than to an operating system or login shell. The development of this interface specification was led by Intel Corporation and is supported by more than 200 computer systems vendors. Cisco, Dell, Hewlett-Packard, Intel, NEC Corporation, SuperMicro and Tyan announced IPMI v1.0 on Sep. 16, 1998, v1.5 on Mar. 1, 2001 and v2.0 on Feb. 14, 2004. Using a standardized interface and protocol allows systems-management software based on IPMI and/or similar OOB management technologies to manage multiple separate servers. As a message-based, hardware-level interface specification, IPMI operates independently of the operating system (OS) to allow administrators to manage a system remotely in the absence of an operating system or of the system management software. Thus IPMI functions can work in any of three scenarios: (a) before an OS has booted, e.g. allowing, for example, the remote monitoring or changing of BIOS settings; (b) when the system is powered down; (c) after OS or system failure—the key characteristic of IPMI compared with in-band system management such as by remote login to the operating system using SSH.

Data Center Manageability Interface (DCMI): The DCMI specifications are derived from Intelligent Platform Management Interface (IPMI) 2.0, which has been widely adopted by the computing industry for server management and system-health monitoring. Both DCMI and IPMI help lower the overall costs of server management by enabling customers to save time, maximize IT resources, and potentially manage multi-vendor environments in the same way. DCMI provides several benefits including, but not limited to: (a) Highly compatible with existing server platforms and management infrastructure because of DCMI's compliance with the IPMI standard; (b) Optimized to cover the core interfaces and functions that are required by data center servers; (c) Streamlined approach enables hardware and software makers to more easily implement and use the management functionality; (d) The DCMI specifications define a uniform set of monitoring, control features, and interfaces that target the common and fundamental hardware management needs of server systems that are used in large deployments within data centers, such as Internet Portal Data Centers (IPDCs). This includes capabilities such as secure power and reset control, temperature monitoring, event logging, and others.

Out-of-band Management Application: Out-of-band management applications provides consolidated access, change management and configuration management for disparate devices capable of out-of-band management like serial console servers, KVM switches, power management appliances and service processor managers. It also provides the capability to manage diverse IT assets connected to these out-of-band tools from a single consolidated view. There are several OOB management functions that IT administrators perform including, but not limited to, device monitoring, diagnostics, asset tracking & management, software/firmware updates, remote control via remote KVM (Keyboard, Video & Mouse).

Present challenge: For the purpose of device/system maintenance, the service processors are typically accessible through either a dedicated Ethernet interface (out-of-band) or a shared data Ethernet interface (sideband). Since service processors require an extra Ethernet connection and IP address per server, this translates into extra costs. These costs do not only arise from the need to have an additional Ethernet switch port available, but also from maintenance of that connection in accordance to the company's policies. Further, a majority of the times, a separate/dedicated network needs to be provisioned to provide true-out-of-band management capability, such that in case the primary Ethernet interface itself is the source of fault, the administrators can still reach the system to perform out-of-band management. The aforementioned process is cumbersome and inefficient. Additionally, unlike the primary Ethernet interface of the computing device, the Ethernet interface for out-of-band management is utilized for a fraction of a time over the lifespan of a computer system, typically only when the computer system requires troubleshooting, which, more often than not, makes it hard for IT organizations to justify the cost of enabling OOB management capabilities within their networks at a large scale.

### SUMMARY

Provided herein are systems and methods for performing out-of-band management (e.g. IPMI, DCMI, remote KVM, Intel AMT or similar technology) of one or more computing devices, using its out-of-band (OOB) service processor and an on-board or attached communication module, which is capable of communicating over a wireless wide area network (WWAN) and optionally over IP-based network. The OOB service processor is capable of communicating over WWAN regardless of the state of in-band processor and operating system of the computing device. Via WWAN, the computing device communicates with the M2M management platform, which in-turn, allows an out-of-band management application (running on a remote computing device) send/receive information to/from the computing device.

In some embodiments, provided herein are systems and methods that provide an alternative way of connecting to the remote server using the cellular data connection instead of the traditional Ethernet connection for IP connectivity.

In some embodiments, the systems and methods comprise a server or a computer system having either on-board or add-on OOB service processor powering IPMI or similar OOB technology. In some embodiments, the IPMI/OOB service processor device/card has an on-board or add-on cellular communication module (GSM or CDMA) that enables the communication (with an option for external antenna if needed). Alternatively the OOB service processor may also have an Ethernet connection port, thereby providing dual communication capability.

In some embodiments, the methods comprise one or more or all of the steps of: a) activating a cellular device on a server/computer system using an M2M Service (e.g., wherein the M2M service provides a secure method (VPN, user authentication) to connect to the remote server and allows bi-directional transmission of OOB management data over the cellular data connection); b) the M2M service assigns a unique identifier in addition to unique SIM ID, such as a public or private IP address to a given cellular device; c) system administrators use an IP address of one or more such servers in the OOB management application/service of their choice to manage remote servers and get real time diagnostic and health information of the remote servers.

### BRIEF DESCRIPTION OF THE DRAWINGS

The systems, devices, and methods described herein are illustrated by way of example, and not by way of limitation, in the accompanying figures. For simplicity and clarity of illustration, elements illustrated in the figures are not necessarily drawn to scale. For example, the dimensions of some elements may be exaggerated relative to other elements for clarity. In the following figures:

FIG. 1 is a simple block diagram of one embodiment of a system configured to perform out-of-band (OOB) management of a computing device over a wireless wide-area network (WWAN).

FIG. 2 is a simplified flow diagram of one embodiment of a method to activate the WWAN service on the remote computing device in FIG. 1 and register the device with M2M service and OOB Management application.

FIG. 3 is a simplified flow diagram of one embodiment of executing one or more OOB management operations using system and devices in FIG. 1.

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details such as logic implementations, opcodes, means to specify operands, resource partitioning/sharing/duplication implementations, types and interrelationships of system components, and logic partitioning/integration choices may be set forth in order to provide a more thorough understanding of the present disclosure. It will be appreciated, however, by one skilled in the art that embodiments of the disclosure may be practiced without such specific details. In other instances, control structures, gate level circuits, and full software instruction sequences may have not been shown in detail in order not to obscure the disclosure. Those of ordinary skill in the art, with the included descriptions, will be able to implement appropriate functionality.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Some embodiments of the disclosure may be implemented in hardware, firmware, software, or any combination thereof. Embodiments of the disclosure implemented in a computer system may include one or more bus-based interconnects between components and/or one or more point-to-point interconnects between components. Embodiments of the invention may also be implemented as instructions stored on a machine-readable, tangible medium, which may be read and executed by one or more processors. A machine-readable, tangible medium may include any tangible mechanism for storing or transmitting information in a form readable by a machine (e.g., a computing device). For example, a machine-readable, tangible medium may include read only memory (ROM); random access memory (RAM); magnetic disk storage media; optical storage media; flash memory devices; and other tangible mediums.

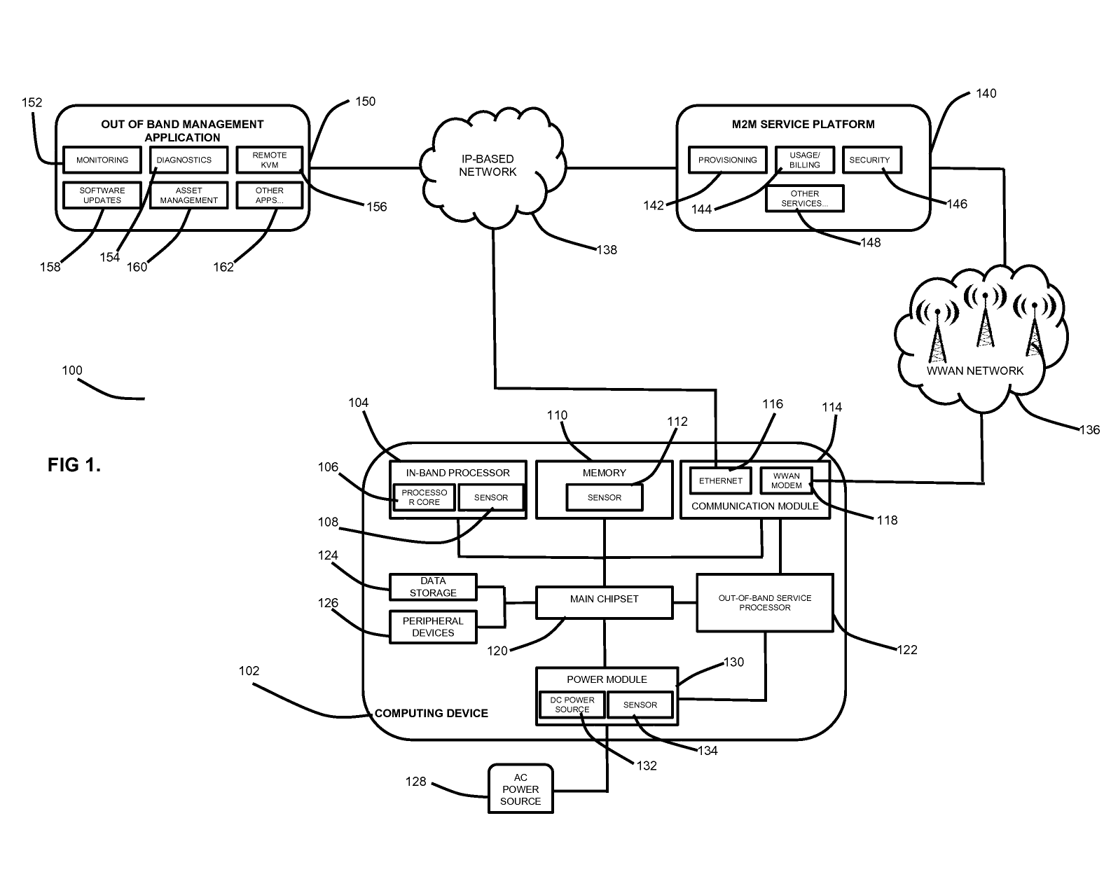

Referring now to FIG. 1, a system 100 configured to provide out-of-band (OOB) management over a wireless wide-area network (WWAN) 136 is shown, via which the computing device 102 connects to the M2M Service Platform 140. On the other end, the an out-of-band management application 150, running on any remote system such as a computer or a server, connects with the M2M Service platform over Internet Protocol (IP) based network 138. In some embodiments, the system 100 may include computing device 102 connecting with the IP-based network to communicate with M2M service platform and/or OOB management application.

The computing device 102 may be embodied as any type of electronic device capable of performing the functions described herein. For example, the computing device 102 may be embodied as a computer server, computer workstations, computer server racks, uninterruptible power supplies (UPS), network firewall equipment, network switch and router equipment, or other computer-based device.

The computing device 102 includes an in-band processor 104 which may have one or more processor core 106 and may have a sensor 108; an out-of-band (OOB) service processor 122; a main chipset 120; a memory 110, which may contain a sensor 112; one or more communication module 114, and power module 130. In some embodiments, the computing device 102 may also include one or more data storage devices 124 and/or one or more additional peripheral devices 126. In some illustrative embodiments, several of the foregoing components may be incorporated on a motherboard of the computing device 102, while other components may be communicatively coupled to the motherboard via, for example, a peripheral port. Furthermore, it should be appreciated that the computing device 102 may include other components, sub-components, and devices commonly found in a computer and/or computing device, which are not illustrated in FIG. 1 for clarity of the description.

The in-band processor 104 of the computing device 102 may be any type of processor capable of executing software/firmware, such as a microprocessor, digital signal processor, microcontroller, or the like. The in-band processor 104 is illustratively embodied as a single core processor having a processor core 106 and a single sensor 108. However, in other embodiments, the in-band processor 104 may be embodied as a multi-core processor having multiple processor cores 106 and multiple sensors 108. Additionally, the computing device 102 may include additional in-band processors 104 having one or more processor cores 106. The in-band processor 104 is generally responsible for executing a software stack, which may include an operating system and various applications, programs, libraries, and drivers resident on the computing device 102. The sensor 108 could be for measuring various data points/signals, such as CPU temperature.

The main chipset 120 of the computing device 102 may include a memory controller hub (MCH or “northbridge”), an input/output controller hub (ICH or “southbridge”), and a firmware device. In such embodiments, the firmware device may be embodied as a memory storage device for storing Basic Input/Output System (BIOS) data and/or instructions and/or other information. However, in other embodiments, chipsets having other configurations may be used. For example, in some embodiments, the main chipset 120 may be embodied as a platform controller hub (PCH). In such embodiments, the memory controller hub (MCH) may be incorporated in or otherwise associated with the in-band processor 104.

The chipset 120 is communicatively coupled to the in-band processor 104 via a number of signal paths. These signal paths (and other signal paths illustrated in FIG. 1) may be embodied as any type of signal paths capable of facilitating communication between the components of the computing device 102. For example, the signal paths may be embodied as any number of wires, cables, light guides, printed circuit board traces, via, bus, intervening devices, and/or the like.

The memory 110 of the computing device 102 is also communicatively coupled to the chipset 120 via a number of signal paths. The memory 110 may be embodied as one or more memory devices or data storage locations including, for example, dynamic random access memory devices (DRAM), synchronous dynamic random access memory devices (SDRAM), double-data rate synchronous dynamic random access memory device (DDR SDRAM), flash memory devices, and/or other volatile memory devices. Additionally, although only a single memory device 110 is illustrated in FIG. 1, in other embodiments, the computing device 102 may include additional memory devices. The operating system, applications, programs, libraries, and drivers that make up the software stack executed by the in-band processor 104 may reside in memory 110 during execution. Furthermore, software and data stored in memory 110 may be swapped between memory 110 and one or more data storage devices 124 as part of memory management operations.

The communication module 114 of the computing device 102 may be embodied as any number of devices and circuitry for enabling communications between the computing device 102 and one or more remote devices/systems (such as remote computing devices similar to 102, or those running OOB Management application 150 or M2M Service platform 140) over the IPN 138 and/or the WWAN 136. For example, communication module 114 includes a wireless communication modem/interface 118 for facilitating communications over the WWAN 136. The wireless network interface 118 may be illustratively embodied as a GSM, 3G, or 4G modem having a wireless transceiver. In such embodiments, the wireless modem 118 will include a SIM card (not shown) with an International Mobile Equipment Identity (IMEI) that uniquely identifies the computing device 102 on the WWAN 1136. Among other types of communications, the wireless modem 118 allows the computing device 102 to send and receive IP data communication according to the appropriate protocol over the WWAN 136. In some embodiments, the communication module 114 may also include one or more wired or wireless Ethernet network interfaces 116 to facilitate IP-based wired and/or wireless communications over the IPN 138. Communication module 114 is also communicatively coupled to the main chipset 120 via a number of signal paths, allowing the in-band processor 104 to access the networks 136, 138.

The components of computing device 102, including in-band processor 104, main chipset 120, memory 110, and communication module 114, are also operably coupled to power module 130. The power module 130 may be embodied as a circuit capable of drawing power from an AC commercial power source 128, a DC battery power source 132, or both. In some embodiments the power module 130 may also feature one or more sensors 134 that measure elements such as voltage, charge etc. To conserve energy, the computing device 102 may be placed in several reduced-power operational states when not being actively used. For example, the computing device 102 may be placed in a powered down or “off” state in which few, if any, components of the computing device 102 receive power from the power circuitry 130. Alternatively, the computing device 102 may be placed into various “sleep” or “hibernate” states in which some, but not all, components of computing device 102 receive power from the power circuitry 130. For instance, a “sleep” state may provide power to a volatile memory 110 (in order to retain data) but not to the in-band processor 104. Such a reduced-power operational state conserves energy while allowing the computing device 102 to return quickly to a full-power operational state.

The out-of-band (OOB) service processor 122 is distinct from and generally operates independently of the in-band processor 104. The OOB service processor 122 may also be embodied as any type of processor capable of executing software, such as a microprocessor, digital signal processor, microcontroller, or the like, including one or more processors having one or more processor cores (not shown). The OOB processor 122 may be integrated into the chipset 120 on the motherboard or may be embodied as one or more separate integrated circuits disposed on an expansion board that is communicatively coupled to the chipset 120 via a number of signal paths. The OOB processor 122 may also be communicatively coupled to various components of the computing device 102, such as the memory 110 and the communication module 114, via a number of signal paths. Alternatively or additionally, the OOB processor 122 may include built-in components with similar functionality, such as a dedicated memory and/or dedicated communication circuitry (not shown).

The OOB processor 122 is configured for managing particular functions of the computing device 102 irrespective of the operational state of the in-band processor 104. To facilitate such independent operation, the OOB processor 122 may be provided with an independent connection to the power circuitry 130, allowing the OOB processor 122 to retain power even when other components of the computing device 102 are powered down or turned off. Furthermore, the OOB processor 122 may be provided with one or more independent network interfaces via communication module 114, which is also provided with an independent connection to the power module 130, allowing out-of-band communications over the IPN 138 and/or the WWAN 136. In other words, the OOB processor 122 is able to communicate directly with devices on the networks 136, 138 (such as remote computing devices similar to 102, or those running OOB Management application 150 or M2M Service platform 140), outside of the operating system running on in-band processor 104. In fact, this communication may take place without the user's knowledge. The OOB processor 122 is also capable of causing 102 to return the computing device to a full-power operational state, including booting the operating system. In summary, the OOB processor 122 may operate intelligently based on incoming queries/commands and communicate across the networks 136, 138 whether the in-band processor 104 is turned off, running on standby, being initialized, or in regular operation and whether the operating system is booting, running, crashed, or otherwise.

In some illustrative embodiments, the OOB processor 122 may be implemented using Intelligent Platform Management Interface (IPMI) or Intel® Active Management Technology (Intel® AMT) or similar OOB management protocols developed by different bodies or companies. For example IPMI embedded platform technology enables out-of-band access to hardware and software information stored in non-volatile memory on each endpoint device, eliminating the need for a functioning operating system and many of the software agents found in other management tools.

As discussed above, the computing device 102 may also include one or more data storage devices 124 and one or more peripheral devices 126. In such embodiments, the chipset 120 is also communicatively coupled to the one or more data storage devices 124 and the one or more peripheral devices 126 via a number of signal paths. The data storage device(s) 124 may be embodied as any type of device configured for the short-term or long-term storage of data such as, for example, memory devices and circuits, memory cards, hard disk drives, solid-state drives, or other data storage devices. The peripheral device(s) 126 may include any number of peripheral devices including input devices, output devices, and other interface devices. For example, the peripheral devices 126 may include a display, a mouse, a keyboard, and/or one or more external speakers of the computing device 102. The particular devices included in the peripheral devices 126 may depend upon, for example, the intended use of the computing device.

The IPN 138 is embodied as, or otherwise include, any number of wired and/or wireless IP-based communications networks such as IP-based local area networks (LAN), IP-based wide area networks (WAN), and/or publicly available global networks (e.g., the Internet). Additionally, the IPN 1038 may include any number of additional devices to facilitate communication between the computing device 102 and the remote computing device similar to 102 such as routers, switches, intervening computers, servers or those running OOB Management application 150 or M2M Service platform 140, and the like.

As described above, the WWAN 136 is a wireless wide-area network that covers a relatively large geographic area and uses mobile telecommunication cellular network technologies to communicate data. For example, in some embodiments, WWAN 136 may be a cellular radio network configured according to the GSM (Groupe Special Mobile), 3G, 4G or LTE standard. In such embodiments, the WWAN 110 includes capabilities to transmit IP data communication (not shown) between the computing device 102 and remote computing devices similar to 102, or those running OOB Management application 150 and/or with M2M Service platform 140. Additionally, the WWAN 136 may include any number of additional devices (such as routers, switches, cell towers, intervening computers, servers) to facilitate communication between the computing device 102 and the remote computing devices running OOB management application 150 and with M2M Service Platform 140.

In some embodiments, the M2M service platform 140 is embodied as a system supporting one or more operations to facilitate machine-to-machine (M2M) communication and management of computing devices such as 102 via those devices running OOB management application 150, over IPN 138 or WWAN 136 or both. In some embodiments, the M2M service platform 140 is also embodied as a stand-alone system run and operated by an organization for private use or as a service offering hosted in the cloud by a provider or a wireless carrier designed to be used by several customers and capable of supporting large number of M2M device communications. The M2M service platform 140 may offer many operational functionalities, including but not limited to, Provisioning 142 (capabilities to provision devices, activate/deactivate service and/or wireless connectivity etc.), Usage/Rate Plan Management/Billing 144 (capability to track usage of WWAN service or device and manage billing thereof), Security 146 (capability to ensure security of data within and during network transmission either by the way of private network path, encryption or VPN). In some embodiments, the M2M Service Platform 140 offers other services 148 such as custom application integration via APIs, or specific monitoring and alerting capabilities.

As described above, the out-of-band (OOB) management application 150 is a stand-alone or hosted software application (running on individual computer, server, group of servers or virtualized systems) that provides consolidated access, change management and configuration management for disparate devices such as computing device 102, over either IP-based network 138 or WWAN 136 or both. In some embodiments, the OOB management application may be designed to provide OOB management functions for one or more of OOB management protocols such as IPMI, Intel's AMT or DCMI, by connecting with the remote computing device such as 102 via communication module 114 either over Ethernet interface 116 or WWAN modem 118. The communication can either be direct or can be facilitated by the M2M service platform 140. The OOB management application 150 may offer one or more functions, including but not limited to, Monitoring 152, Diagnostics 144, Remote Keyboard-Mouse-Video (KVM) 156, Software Updates 158, Asset Management and Tracking 160, and other related applications 162 (not described here). At a high level, the Monitoring function 152 monitors and reports system state/health or connectivity of one or more remote computing devices illustrated by computing device 102 or similar, and in some embodiments monitoring low level measurements such as those provided by sensors 108, 112, 134 etc. The Diagnostics capability 154 provides capability to remotely diagnose and troubleshoot issues on remote computing device 102 or similar by using variety of mechanisms such as log files, event triggers etc. The Remote KVM function 156 allows system administrators to get console access of the remote computing device 102 along with ability to see exactly what the user would see on the video display of the computing device 102 and send keyboard and mouse commands remotely. The software update function 158 allows the system administrators to perform updates to the software on remote computing device 102 or install software patches or similar updates without having to be present locally. Similarly the Asset Management function 160 can allow the administrators to track and identify the portfolio of computing devices similar to 102, potentially with help of additional sensors such as location sensor (not show) or unique ID/device tampering sensor(s) (not shown).

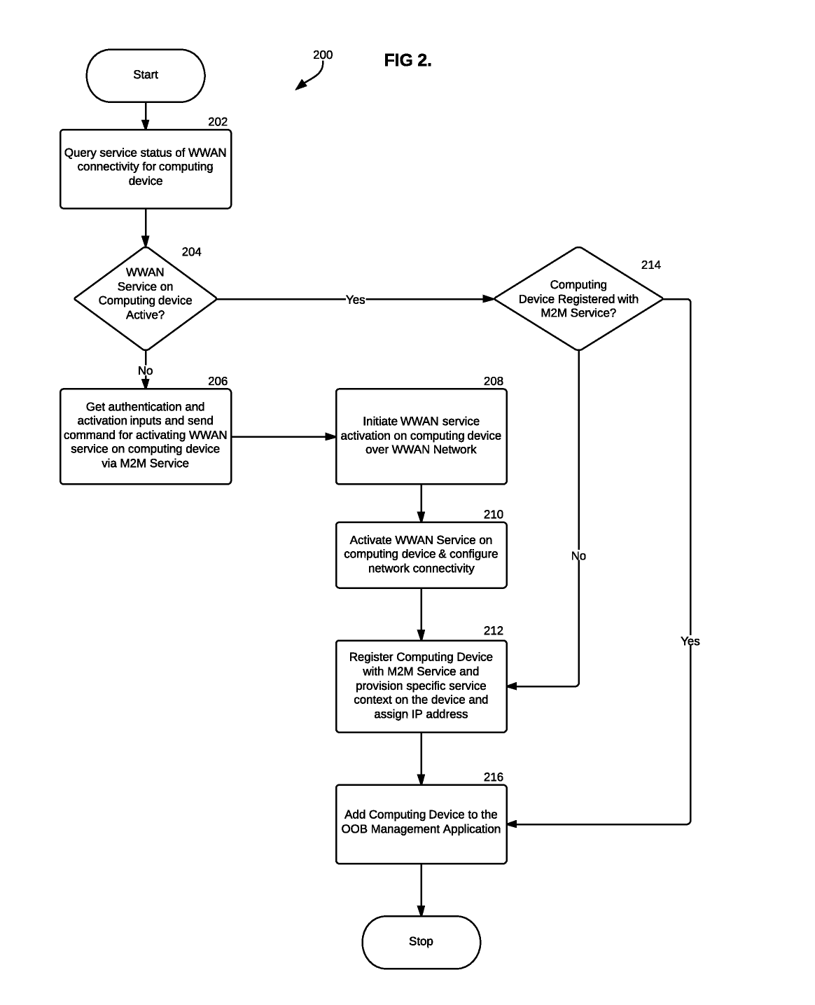

Several of the features of OOB service processor 122, including its persistent power module 130 and independent communication channel, allow the system 100 to provide remote OOB management over the WWAN 136 using data network and M2M Service Platform 140. To do so, as illustrated in FIG. 2, the computing device 102 may be configured to execute a method 200 for remote activation and/or device registration over the WWAN 136. The method 200 may be executed by either OOB management application 150 or M2M service platform 140 itself or a combination, coupled with for example, the OOB service processor 122 on remote computing device 102. To make this happen, the OOB service processor 122 may work in conjunction with other components of the computing device 102, which may interact with other components of the system 100. The method 200 may allow remote activation and/or registration of the computing device 102 or many similar devices for the purpose of OOB management.

FIG. 2 illustrates a simplified flow diagram of one embodiment of a method to activate the WWAN service on the remote computing device in FIG. 1 and register the device with M2M service and OOB Management application. Referring to FIG. 2., the method 200 begins with block 202 in which OOB management application 150 in conjunction with M2M Service Platform 140 executes a query to determine the WWAN connectivity status of remote computing device 102. The method then proceeds to block 204 where it is determined whether WWAN connectivity with the remote computing device 102 is established or not. In some embodiments, if the connectivity is established, then it is deemed that the WWAN service is already activated. Though depending on actual usage, the specific validation steps might vary and in those cases the method shall proceed to block 214 to determine whether or not the remote computing device 102 is registered with M2M service. In some embodiments, if the response in block 204 is such that the WWAN service on remote computing device is not active, then the method proceeds to block 206, which illustrates a method to solicit the necessary authentication and/or activation inputs and send the command via M2M service platform 140 for the purpose to activate WWAN service on remote computing device 102. The method then proceeds to block 208 where the WWAN service activation sequence is initiated over WWAN. In some embodiments, the block 208 involves one or both networks 136 and 138 to perform the remote activation method. The method further proceeds to block 210 where the process of activation of WWAN service and necessary network configurations are carried out. Subsequently in some embodiments, the method proceeds to block 212, where the remote computing device 102 is registered within M2M service platform 140 and may also include configuration of specific application/service contexts and acquiring and establishing the secure or general network path/route and the IP address for the network connectivity. If the state of method is currently exiting from block 214 where it is deemed that the computing device is not registered with M2M service, then in some embodiments the method may also proceed to block 212. Subsequently, in some embodiments, the method may proceed to block 216, where the remote computing device 102 is added to OOB Management application 150 along with other necessary information/configuration such as IP address, credentials etc.

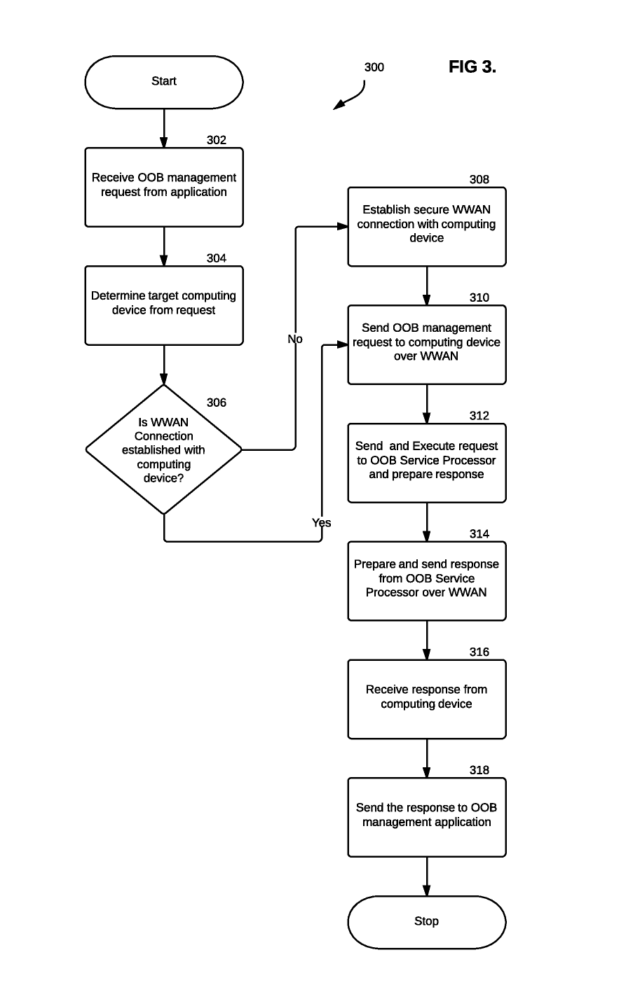

FIG. 3 illustrates a simplified flow diagram of one embodiment of executing one or more OOB management operations using system and devices in FIG. 1. Referring to FIG. 3., the method 300 begins with block 302 in which OOB management application 150 in conjunction with M2M Service Platform 140 issues an OOB management request, for example temperature reading via sensor 108 of the in-band processor 104 within computing device 102. The method proceeds to block 304 to determine the target computing-device (for example computing device 102 in FIG. 1) based on the request received from block 302. Moving forward, the routine in block 306 determines whether or not WWAN connectivity is established with the target computing-device 102. In case the WWAN connectivity with device 102 is not established the method proceeds to block 308, where a secure connection over WWAN 136 with the computing device 102 is established. Subsequently, or if within block 306 it is determined that WWAN connectivity with computing device 102 is already established, the method proceeds to block 310, where the OOB management request gets sent to the computing device 102 over WWAN 136. Upon receipt, in block 312, the OOB management request is sent to and executed by the OOB service processor 122 and a response is prepared. The method then proceeds to block 314 where the response is sent out by OOB service processor 122 of the computing device 102 via WWAN modem 118 within communication module 114, over WWAN 136. In the next block 318 M2M application 140 receives the response over WWAN 136 and within block 318 the response is sent back to OOB management application.

It must be appreciated that while the example described within method 300 is a simple OOB management request, similar or more involved OOB management requests can be carried out with same general process where the specifics depend on the application or device implementation as well as on the overall configuration of the networks and the system.

I claim:

1. A system comprising a computing device comprising an out-of-band service processor and a cellular communication module in send/receive communication with an out-of-band management application running on a remote device.

2. The system of claim 1, wherein said computing device is a server.

3. The system of claim 1, wherein said service processor is an on-board service processor.

4. The system of claim 1, wherein said service processor is an add-on service processor.

5. The system of claim 1, wherein said service processor is powering IPMI or similar out-of-band management technology.

6. A method comprising performing out-of-band management of one or more computing devices using an out-of-band service processor and a wireless communication module.

7. A method comprising performing out-of-band management of one or more computing devices using a system of claim 1.

8. Software on a computer readable medium configured to carry out the method of claim 6.
